(19) United States
(12) Patent Application Publication
(10) Pub. No.: US 2023/0297876 A1
(43) Pub. Date: Sep. 21, 2023

(54) AUTOMATED TIME-SERIES PREDICTION PIPELINE SELECTION

(71) Applicant: INTERNATIONAL BUSINESS MACHINES CORPORATION, Armonk, NY (US)

(72) Inventors: Xuan-Hong Dang, Chappaqua, NY (US); SYED YOUSAF SHAH, Yorktwon Heights, NY (US); Dhavalkumar C. Patel, White Plains, NY (US); Wesley M. Gifford, Ridgefield, CT (US); Petros ZERFOS, New York, NY (US)

(21) Appl. No.: 17/697,267

(22) Filed: Mar. 17, 2022

(51) Int. Cl. G06N 20/00; G06N 5/02

(52) U.S. Cl. CPC G06N 20/00; G06N 5/02

(57) ABSTRACT

Selecting a time-series forecasting pipeline by receiving target variable time-series data and exogenous variable time-series data, generating a regular forecasting pipeline comprising a model according to the target variable time-series data, generating an exogenous forecasting pipeline comprising a model according to the target variable time-series data and the exogenous variable time-series data, evaluating the regular forecasting pipeline and the exogenous forecasting pipeline, selecting a pipeline according to the evaluation, and providing the selected pipeline.

### FIELD OF THE INVENTION

The disclosure relates generally to the automated selection of a time-series prediction pipeline. The disclosure relates particularly to the automated selection of a time-series prediction pipeline including exogenous and imputed data.

### BACKGROUND

Automated machine learning has become a trend in developing new machine learning based systems. With time-series modeling, users can collect external information and provide them as exogenous features with expectation of adding more predictive power to a forecasting system.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable the generation, evaluation, and selection, of a suitable time-series forecasting pipeline.

Aspects of the invention disclose methods, systems and computer readable media associated with selecting a time-series forecasting pipeline by receiving target variable timeseries data and exogenous variable time-series data, generating a regular forecasting pipeline comprising a model according to the target variable time-series data, generating an exogenous forecasting pipeline comprising a model according to the target variable time-series data and the exogenous variable time-series data, evaluating the regular forecasting pipeline and the exogenous forecasting pipeline, selecting a pipeline according to the evaluation, and providing the selected pipeline.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

FIG. 3 depicts a cloud computing environment, according to an embodiment of the invention.

FIG. 4 depicts abstraction model layers, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

Current automatic time-series analysis products handle homogenous time-series pipeline, i.e., all pipelines must work on the same set of input and output features, further, current products lack a joint optimizer which concurrently optimizes multiple heterogenous pipelines. Disclosed embodiments provide an automated system and method for time-series forecasting which generates and evaluates multiple multi-variate time-series models, both with and without exogenous time-series data. Disclosed embodiments utilize data imputation, data transformation, and pipeline generation libraries in the generation, evaluation and selection of forecasting pipelines. Disclosed embodiments include data imputation means to complete partial time-series data streams, the embodiments further mask the imputed data to enable more robust pipeline scoring. Disclosed embodiments evaluate and select an optimal data imputing algorithm for a given input time-series data stream, and masks imputed values, excluding such values from pipeline scoring algorithms to achieve more robust pipeline scoring. Embodiments enable data caching across multiple pipelines, reducing the resource requirements necessary for selecting an optimized forecasting pipeline.

Aspects of the present invention relate generally to generating an optimized timeseries forecasting pipeline according to received target variable and potentially, exogenous variable, data series. Disclosed systems and methods receive time-series data including target variable and/or exogenous variable data, data imputation, data transformation, and pipeline generation libraries, as well as a user selection regarding the use of pipelines including exogenous data. Systems impute missing time-series data after selecting an optimal method for generating imputed data for each series. Systems mask, or otherwise mark imputed data such that the data does not contribute to the evaluation scoring for the generated pipelines. Systems generate regular target variable pipeline as well as exogenous variable data pipelines. Systems rank generated pipelines according to the evaluation scores and output the top ranked pipelines for use in forecasting.

In accordance with aspects of the invention there is a method for automatically generating and selecting a time-series forecasting pipeline, while also optimizing the selection using data from the input time-series data sets. Methods include imputing missing time-series data using an optimal imputation algorithm selected according to the input data, training regular and exogenous pipelines using input data, evaluating the trained pipelines using holdout data, and providing highest ranking pipelines for forecasting future time-series data. Methods split input data into training, testing and holdout data sets, according to a user specified event horizon magnitude. Methods train regular and exogenous pipelines using allocated portions of the data sets including imputed values. Methods train regular pipelines to a point equivalent to the present minus the specified event horizon, and train exogenous pipelines using exogenous timeseries data, including imputed values, up to the present time and regular time-series data including imputed values, up to the present time minus the event horizon. Methods evaluate the trained pipelines using the testing data sets with imputed values masked so as to not impact the evaluation scores. Methods generate, train and evaluate pluralities of n regular and exogenous pipelines, resulting in n pipeline evaluation scores for each of the regular and exogenous pipelines. After all input data has been allocated to pipelines which have been trained and evaluated, methods return the top ranked pipelines as an output for forecasting used by the user.

Aspects of the invention provide an improvement in the technical field of time-series forecasting pipeline generation. Systems and methods receive input time-series data for at least a target variable, and potentially for exogenous variables as well. Methods and systems impute missing data values, maintaining a record of imputed values for each of the target and exogenous time-series sets. Using portions of the input data, methods and systems generate, train and evaluate time-series pipelines, yielding a ranked set of candidate pipelines for user forecasting. Top ranked pipelines enable users to time-series data. Disclosed methods and systems enable cross-pipeline sharing of cached data between regular and exogenous pipelines as top-ranked pipelines switch during evaluation. Such data cross pipeline caching requires fewer computing resources to achieve an optimal forecasting pipeline, and also takes less time resulting in an improved system performance.

Aspects of the invention also provide an improvement to computer functionality. In particular, implementations of the invention are directed to a specific improvement to the way generated time-series pipeline candidates are optimized by only training top-ranked pipelines as new input data is allocated for consideration, by caching and sharing feature generators and data transformers across multiple pipelines, reducing the need to re-generate such elements with each data allocation. Further, disclosed methods and systems provide improved prediction accuracy by considering both regular and exogenous pipeline models and by concurrently optimizing both the regular and exogenous model candidates. Disclosed method further provide explain ability of the output forecasting pipelines increasing the transparency of forecasting results for the users.

As an overview, a time-series forecasting pipeline predicts time-series data for one or more target variables according to a model trained using historic target and potentially exogenous variable data. Input data may be incomplete requiring methods and systems to impute missing values during the training phase of the process. Such imputed values may artificially raise a model’s evaluation score so the values must be accounted for and removed during model evaluation to provide more robust and accurate evaluations. Regular and exogenous pipeline candidates may be optimized together yielding a fairer overall evaluation and outputting the optimal pipeline for forecasting. Caching data across multiple pipeline models during training reduces the computational loading required by the overall process, saving time and resources.

In an embodiment, one or more components of the system can employ hardware and/or software to solve problems that are highly technical in nature (e.g., receiving historic target variable and exogenous time-series data, generating regular and exogenous time-series forecasting pipelines, evaluating the generated time-series forecasting pipelines, selecting an optimal time-series forecasting pipeline, and providing the selected optimized time-series forecasting pipeline for user predicting time-series target variable values, etc.). These solutions are not abstract and cannot be performed as a set of mental acts by a human due to the processing capabilities needed to facilitate time-series forecasting, for example. Further, some of the processes performed may be performed by a specialized computer for carrying out defined tasks related to time-series target variable forecasting. For example, a specialized computer can be employed to carry out tasks related to generating target variable time-series forecasting pipelines or the like.

In an embodiment, a method receives time-series input data associated with a target variable, the method may further receive exogenous variable time-series data as well as timeseries indices for each of the target and exogenous data sets and other forecasting parameters such as a prediction horizon, a desired number of “best pipeline”, a holdout set size, specified by a user. The user may further indicate of only pipeline supporting exogenous variable data are to be provided. The method may further receive data imputation, data transformation, and pipeline generation, libraries. In this embodiment, the method responds with the generation of respective regular time-series pipelines for the target variable input time-series data, and exogenous pipelines generated according to both the target and exogenous time-series input data.

In an embodiment, wherein both exogenous and target input time-series data sets are provided, disclosed methods handle the candidate forecasting pipeline in a combined manner. Methods evaluate each time-series data set for missing values. Some forecasting estimators require regularly spaced time-series data to function properly. Input data sets having missing values must be augmented with imputed data to yield sets having the requisite regularly spaced data values. Methods evaluate the input data and determine the form of data imputation which best serves the function of providing the missing data values. In an embodiment, the method evaluates respective stateful and stateless imputers to determine which form works best for the current input data set.

In an embodiment, the method trains stateful imputers once for a pipeline set and stores the trained imputer with the pipeline data. Stateless imputers require no training and simply predict values based upon provided known values. In this embodiment, the method utilizes each of stateful and stateless imputation to predict missing values and then evaluates the overall quality of the input data set plus the imputed values. The augmented set having the highest quality indicates the best data imputer for the input data set. In an embodiment, the method scores differing imputers according to the statistical properties of each augmented data set relative to each other and relative to the original input data set.

In this embodiment, the method tracks the imputed values added to the input data sets. In an embodiment, the method tracks imputed values in a sparse matrix M, associated with the input data sets holding the locations of the imputed values within the respective target and exogenous data sets. The method tracks the relative proportions of input data and imputed data and alerts the user when the proportion of imputed data crosses a defined threshold, such as 10% of the input data, or a second threshold, such as 40% missing data, indicating a low confidence level for any resulting forecasting pipeline. After selection of the data imputation algorithm, missing values are provided for each of the training, testing and holdout data sets of each of the target variable and exogenous variables. The method utilizes same imputation algorithm for all the training and forecasting pipelines associated with a particular input data set. For stateful imputer selection and use, the method benefits overall computing resource use by training a single stateful imputer and utilizing that trained stateful imputer across all input data sets. Imputers may be utilized across both single variable time-series data as well as multi-variable time-series data sets.

In an embodiment, the method splits the chronologically ordered input data into training, testing and holdout data sets. For a given input data set, the split yields a training set of length T, a testing set of length H, h, denotes the desired prediction horizon for the eventual forecasting, and L, denotes the look-back horizon for forecasting.

In an embodiment, the method allocates a block of the training data set of allocation_size, looking back from the most recent data. Allocation_size may be specified by the user or determined by the method according to the overall size of the augmented input data set.

In an embodiment, the method trains target variable pipeline with input data sequences up to a T-h, timepoint. For exogenous pipelines, the method trains candidate pipelines using input sequences up to the T timepoint, except those sequences of target variable time-series data. At any given timepoint t between L and T-h, the future values of exogenous time-series between [t+1, t+h] are provided to the pipeline to forecast values on the target variable time-series with the same range.

After training the candidate target and exogenous pipelines, the method evaluates the performance of each candidate using an optimizer and the testing data sets derived from the original input data sets. In an embodiment, the method evaluates each candidate at each timepoint t in range of 1 and H-h, of the test data sets.

The optimizer allocates the input data between [t-L, t+h] on the exogenous time-series, and [t-L,t] on the target time-series to forecast the range [t+1,t+h], for exogenous pipelines. This process is iterated until reaching time point t=H-h. At this time point, each of the regular (target variable time-series) exogenous (both target and exogenous variable time-series) return sets of predicted values of the same length H, matching the same period of the test set. In an embodiment, the test data used for evaluation does not include the masked values tracked in matrix M.

The optimizer allocates the data between [t-L,t] on the target time-series, for regular pipelines, and evaluates the regular pipeline performance on the range [t+1,t+h], consistent with the evaluation of exogenous pipelines.

For each of the regular and exogenous pipelines, values from L last time points of the training data are used for the first timepoint t=1 in the test set. But no H+h timepoint (to the holdout set) is used for the exogenous pipelines when the evaluation reaches the end of the test set. Both regular and exogenous pipelines return sets of predicted values of the same length which match the length and range H of the testing set. These predicted values are compared against the ground truth test set through regression fit testing in order to compute evaluation scores which are used to rank pipelines. The evaluation scores such as smape, mse, mae, r2 etc. can be chosen by the user and during its computation, imputed data entries can be ignored for better evaluation.

In an embodiment, the method iterates the described steps of allocating training data blocks, training candidate pipelines, and evaluating the trained pipelines, resulting in n evaluation score for each of the regular and exogenous pipelines.

In an embodiment, the method performs a regression fit check for each candidate pipeline on the performance score against the sample size, predicting an evaluation score for a sample size of T. In this embodiment, the method then ranks all candidate pipelines according to their respective predicted scores associated with the test data set of length T. In this embodiment, the method stores the candidate pipelines in a priority-based queue.

In an embodiment, from a time n+1 data allocation step, the method acquires a new data allocation, called next allocation, based on the allocation_size of the top ranked pipeline of the priority-based queue. For an exogenous top-ranked pipeline from the priority-based queue, the method acquires next allocation geometrically based on the characteristics of exogenous + target time-series. For a regular top-ranked pipeline, the method geometrically allocate next allocation based on the characteristics of target time-series. Not all pipelines in the priority-based queue will get this additional data allocation, and not all pipelines in the queue will be trained with this newly allocated data. Only the top-ranked pipeline from each iteration. The top-ranked pipeline can change during pipeline optimization process as pipeline evaluation scores change.

In an embodiment, pipeline ranking and additional allocations -training-evaluation-ranking, continue for the top-ranked pipelines until the entire training data sets have been allocated to pipelines as part of the training-evaluation cycle. After the evaluation of the pipelines trained using the full training set, the method returns the number of top-ranked pipelines specified by the user as desired. The final top-ranked pipelines may be either target variable based or exogenous and target variable based.

In an embodiment, for exogenous pipelines, the method queries the user for future exogenous variable values to support target variable forecasting. The method generates target variable forecast values matching the time period of provided exogenous variable time-series values. A user may explore different future scenarios by providing differing sets of futures exogenous variable time-series data. During forecasting, the method updates the pipeline with new forecast target values and the user-provided exogenous variable values.

In an embodiment, the method caches data across pipelines during training to reduce the computational resource loading associated with the training phase. For exogenous pipeline generation, the method starts with the corresponding target pipeline and reuses the steps of data transformation, including data imputation, data feature engineering, and data estimators applied to the target pipeline in the generation of the exogenous plus target pipeline. In this embodiment, the method caches the data associated with each training data allocation stage, as top-ranked pipeline type for an allocation stage switches between target and exogenous, the method transfers feature engineering and data transformation results from the top-ranked pipeline of the previous allocation stage to the top-ranked pipeline of the current allocation stage, saving resources.

In an embodiment, at data allocation n+1, feature engineering and data transformation are computed for top pipeline(s) and cached. Top pipelines are trained with generated data and pipelines rankings are updated. Next at a new data allocation n+2, the next allocation, is allocated according to: next_allocation=int(rounded_inc_mult*allocation_size), and rounded_inc_mult=int(last_allocation*initial_geo_allocation_increment))/allocation_size. Where rounded_inc_mult, initial_geo_allocation_increment are computed from time-series or specified by the user.

Next, the optimizer checks the priority-based queue to detect whether a top pipeline is switched from exogenous, say pipeline A, to a regular pipeline B (or vice versa). For such pipeline changes: data caching for pipeline A in last_allocation is transferred to pipeline B, excluding features on exogenous time-series data features and the method generates new features for pipeline B on next_allocation segment.

When switching between regular pipeline A and exogenous pipeline B, the method transfers data caching for pipeline A in last_allocation to pipeline B, the method then generates features in last_allocation for exogenous time-series pipeline B. The method then generates new features on both target and exogenous time-series for pipeline B on next_allocation segment.

In an embodiment, the method repeats the steps associated with new data allocations and optimization checks at each new data allocation until all training data is allocated, i.e., when the optimizer allocates the entire training set to train the top pipelines in the priority queue. In an embodiment, the method evaluates the final top-ranked pipelines using the holdout data set such that the final evaluation utilizes data previously unseen by any of the pipeleines.

In an embodiment, the method achieves reduced computational loading and shorter runtimes because only top-ranked pipelines from each previous data allocation participate in each new data allocation and the method shares the results of multiple data transformation steps across the top-ranked pipelines as allocation steps proceed. The method yields a prediction accuracy improvement over typical systems and methods as it evaluates each of the target and target plus exogenous pipelines at each allocation stage and selects the top-ranked pipeline moving forward. Concurrently optimizing both the target and exogenous pipelines ensures a fairer evaluation of the respective pipelines, yielding the most accurate pipeline as a final result.

In an embodiment, pipeline forecast results include explanation factors including feature importance rankings for each of the target and exogenous time-series pipeline forecast results based upon past and future time-series values. Based on coefficients assigned to each timestep [t-L,t] in the target series and [t-L, t+h] in the exogenous time-series, the absolute values of the coefficients can be aggregated in order to rank the degree of importance of each series. Coefficients of the target time-series and on the exogenous time-series also can be varied in order to see the impact of each series on the predicted values against the actual ones, indicating which series has more influence on the future values of the target series being predicted. Disclosed methods indicate a greater emphasis on exogenous feature ranking for instances where forecast values have more reliance upon changes in exogenous variable value changes. In an embodiment, the method provides local interpretable model-agnostic explanations which can generate a set of clauses.

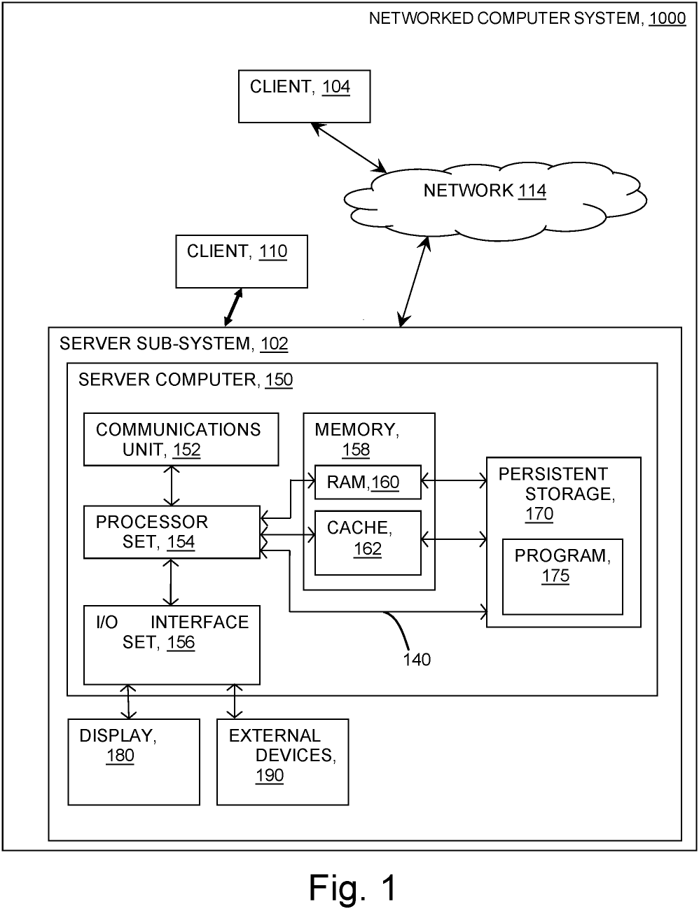

FIG. 1 provides a schematic illustration of exemplary network resources associated with practicing the disclosed inventions. The inventions may be practiced in the processors of any of the disclosed elements which process an instruction stream. As shown in the figure, a networked Client device 110 connects wirelessly to server sub-system 102. Client device 104 connects wirelessly to server sub-system 102 via network 114. Client devices 104 and 110 comprise timeseries data set selection program (not shown) together with sufficient computing resource (processor, memory, network communications hardware) to execute the program. As shown in FIG. 1, server sub-system 102 comprises a server computer 150. FIG. 1 depicts a block diagram of components of server computer 150 within a networked computer system 1000, in accordance with an embodiment of the present invention. It should be appreciated that FIG. 1 provides only an illustration of one implementation and does not imply any limitations with regard to the environments in which different embodiments can be implemented. Many modifications to the depicted environment can be made.

Server computer 150 can include processor(s) 154, memory 158, persistent storage 170, communications unit 152, input/output (I/O) interface(s) 156 and communications fabric 140. Communications fabric 140 provides communications between cache 162, memory 158, persistent storage 170, communications unit 152, and input/output (I/O) interface(s) 156. Communications fabric 140 can be implemented with any architecture designed for passing data and/or control information between processors (such as microprocessors, communications and network processors, etc.), system memory, peripheral devices, and any other hardware components within a system. For example, communications fabric 140 can be implemented with one or more buses.

Memory 158 and persistent storage 170 are computer readable storage media. In this embodiment, memory 158 includes random access memory (RAM) 160. In general, memory 158 can include any suitable volatile or non-volatile computer readable storage media. Cache 162 is a fast memory that enhances the performance of processor(s) 154 by holding recently accessed data, and data near recently accessed data, from memory 158.

Program instructions and data used to practice embodiments of the present invention, e.g., the prediction pipeline selection program 175, are stored in persistent storage 170 for execution and/or access by one or more of the respective processor(s) 154 of server computer 150 via cache 162. In this embodiment, persistent storage 170 includes a magnetic hard disk drive. Alternatively, or in addition to a magnetic hard disk drive, persistent storage 170 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 170 may also be removable. For example, a removable hard drive may be used for persistent storage 170. Other examples include optical and magnetic disks, thumb drives, and smart cards that are inserted into a drive for transfer onto another computer readable storage medium that is also part of persistent storage 170.

Communications unit 152, in these examples, provides for communications with other data processing systems or devices, including resources of client computing devices 104, and 110. In these examples, communications unit 152 includes one or more network interface cards. Communications unit 152 may provide communications through the use of either or both physical and wireless communications links. Software distribution programs, and other programs and data used for implementation of the present invention, may be downloaded to persistent storage 170 of server computer 150 through communications unit 152.

I/O interface(s) 156 allows for input and output of data with other devices that may be connected to server computer 150. For example, I/O interface(s) 156 may provide a connection to external device(s) 190 such as a keyboard, a keypad, a touch screen, a microphone, a digital camera, and/or some other suitable input device. External device(s) 190 can also include portable computer readable storage media such as, for example, thumb drives, portable optical or magnetic disks, and memory cards. Software and data used to practice embodiments of the present invention, e.g., prediction pipeline selection program 175 on server computer 150, can be stored on such portable computer readable storage media and can be loaded onto persistent storage 170 via I/O interface(s) 156. I/O interface(s) 156 also connect to a display 180.

Display 180 provides a mechanism to display data to a user and may be, for example, a computer monitor. Display 180 can also function as a touch screen, such as a display of a tablet computer.

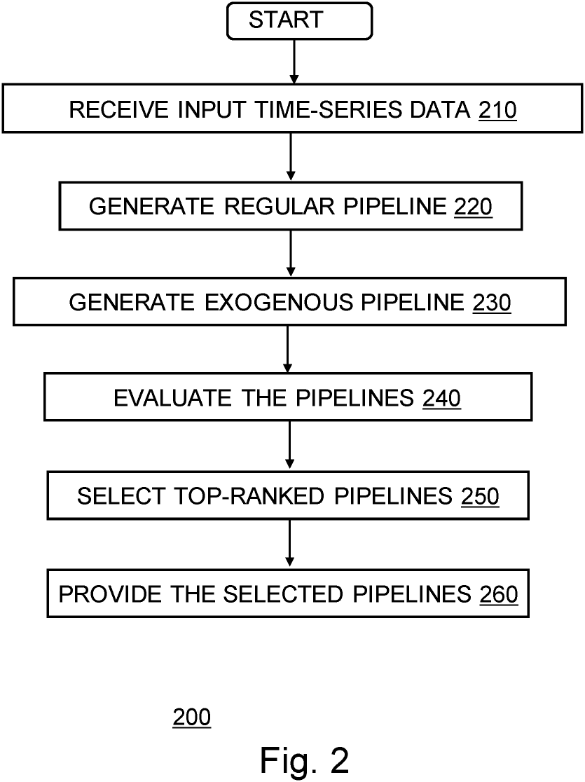

FIG. 2 provides a flowchart 200, illustrating exemplary activities associated with the practice of the disclosure. After program start, at block 210, the method receives target variable and exogenous variable time-series data from a user. The data may be incomplete and the method may evaluate and select a data imputation model to complete the missing data in the respective time-series. The method tracks the imputed data in each time-series and masks the imputed data during pipeline evaluations. The method and system may further receive libraires of data imputation, data transformation and pipeline generation elements. The method divides the provided data into training, testing and holdout data sets. The holdout data set is used to test the performance of the best pipeline chosen by the system on an independent data set which has never been seen by the system. In an embodiment, the system and methods also use the holdout data set to compare the performance of the developed system against the performance of other time-series forecasting models and algorithms in the literature.

At block 220, the method generates a regular time-series forecasting pipeline according to the target variable time-series data including imputed data to complete the series. At block 230 the method generates an exogenous time-series forecasting pipeline according to the combination of the completed target variable time-series data and the completed exogenous variable time-series data.

At block 240 the method evaluates the combination of the regular and exogenous time-series pipelines using a common framework including a series of data allocations from the training data, starting from the most recent data and moving backwards in time to the oldest data. At each stage of new data allocation, the method evaluates each of the regular and exogenous pipelines and ranks the respective pipelines according to the evaluation. The method then proceeds to the next allocation stage using only the top-ranked pipelines, using a number of pipelines specified by the user.

After allocating all training data to the respective pipelines and evaluating the pipelines, at block 250, the method selects the top-ranked pipelines for use in forecasting new target variable values according to the respective evaluation scores. The method receives new exogenous variable data from the user for forecasting use with an exogenous pipeline. As forecasting proceeds, the method updates each of the target and exogenous pipelines with the new and forecast data values.

In an embodiment, at block 260, the method provides the top-ranked pipelines and/or the new forecast values for the target variable, to the user.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics Are as Follows

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models Are as Follows

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models Are as Follows

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

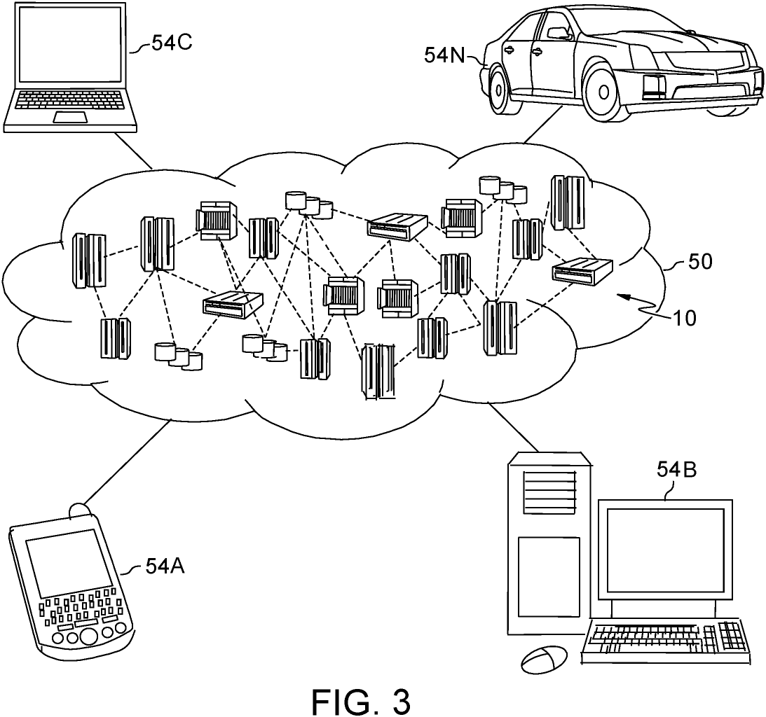

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

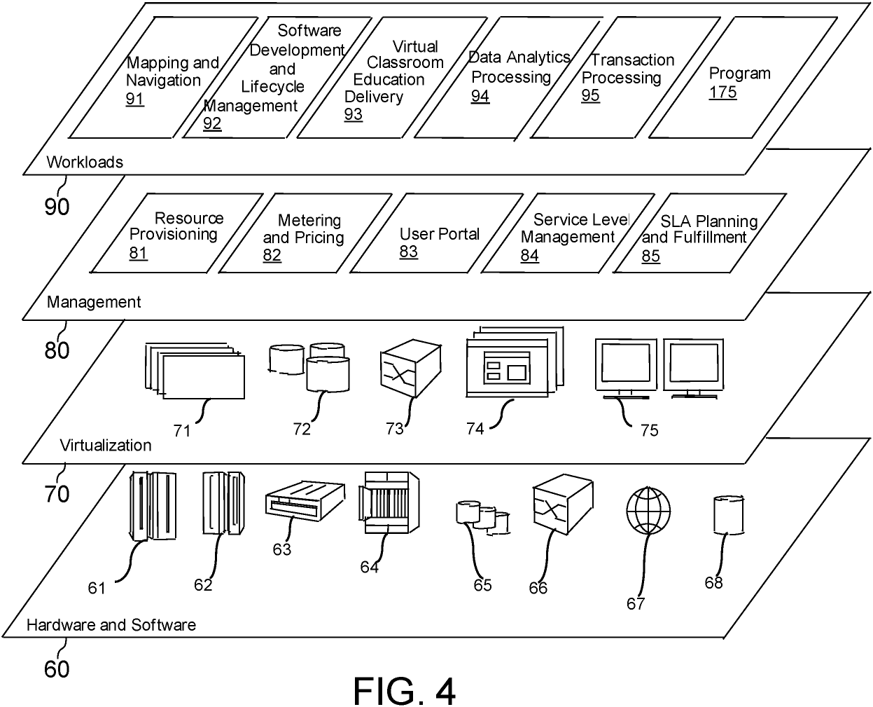

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and prediction pipeline selection program 175.

The present invention may be a system, a method, and/or a computer program product at any possible technical detail level of integration. The invention may be beneficially practiced in any system, single or parallel, which processes an instruction stream. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, or computer readable storage device, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer implemented method for selecting a time-series forecasting pipeline, the method comprising:
receiving, by one or more computer processors, target variable time-series data and exogenous variable time-series data;
generating, by the one or more computer processors, a regular forecasting pipeline comprising a model according to the target variable time-series data;
generating, by the one or more computer processors, an exogenous forecasting pipeline comprising a model according to the target variable time-series data and the exogenous variable time-series data;
evaluating, by the one or more computer processors, the regular forecasting pipeline and the exogenous forecasting pipeline;
selecting, by the one or more computer processors, a pipeline according to the evaluation; and
providing, by the one or more computer processors, the selected pipeline.

2. The computer implemented method according to claim 1, further comprising:
receiving, by the one or more computer processors, libraries for at least one of data imputation, data transformation, and pipeline generation; and
generating, by the one or more computer processors, a pipeline according to the at least one of the data imputation, data transformation and pipeline generation library.

3. The computer implemented method according to claim 1, further comprising providing, by the one or more computer processors, an explanation of forecast time-series data using information from at least one of the target variable time-series data and the exogenous variable time-series data.

4. The computer implemented method according to claim 3, further comprising providing, by the one or more computer processors, an explanation of forecast time-series data according to past and future exogenous variable data.

5. The computer implemented method according to claim 1, further comprising concurrently evaluating, by the one or more computer processors, the regular and exogenous pipelines under a common framework.

6. The computer implemented method according to claim 1, further comprising imputing, by the one or more computer processors, missing data for at least one of the target variable time-series data and the exogenous variable time-series data.

7. The computer implemented method according to claim 6, further comprising masking, by the one or more computer processors, the imputed data.

8. A computer program product for selecting a time-series forecasting pipeline, the computer program product comprising one or more computer readable storage devices and collectively stored program instructions on the one or more computer readable storage devices, the stored program instructions comprising instructions, which when executed, cause a computing system to:
receive target variable time-series data and exogenous variable time-series data;
generate a regular forecasting pipeline comprising a model according to the target variable time-series data;
generate an exogenous forecasting pipeline comprising a model according to the target variable time-series data and the exogenous variable time-series data;
evaluate the regular forecasting pipeline and the exogenous forecasting pipeline;
select a pipeline according to the evaluation; and
provide the selected pipeline.

9. The computer program product according to claim 8, the stored program instructions further causing the computing system to:
receive libraries for at least one of data imputation, data transformation, and pipeline generation; and
generate a pipeline according to the at least one of the data imputation, data transformation and pipeline generation library.

10. The computer program product according to claim 8, the stored program instructions further causing the computing system to provide an explanation of forecast time-series data using information from at least one of the target variable time-series data and the exogenous variable time-series data.

11. The computer program product according to claim 10, the stored program instructions further causing the computing system to provide an explanation of forecast time-series data according to past and future exogenous variable data.

12. The computer program product according to claim 8, the stored program instructions further causing the computing system to concurrently evaluate the regular and exogenous pipelines under a common framework.

13. The computer program product according to claim 8, the stored program instructions further causing the computing system to impute missing data for at least one of the target variable time-series data and the exogenous variable time-series data.

14. The computer program product according to claim 13, the stored program instructions further causing the computing system to mask the imputed data.

15. A computer system for selecting a time-series forecasting pipeline, the computer system comprising:
one or more computer processors;
one or more computer readable storage devices; and stored program instructions on the one or more computer readable storage devices for execution by the one or more computer processors, the stored program instructions comprising instructions, which when executed, cause the computer system to:
receive target variable time-series data and exogenous variable time-series data;
generate a regular forecasting pipeline comprising a model according to the target variable time-series data;
generate an exogenous forecasting pipeline comprising a model according to the target variable time-series data and the exogenous variable time-series data;
evaluate the regular forecasting pipeline and the exogenous forecasting pipeline;
select a pipeline according to the evaluation; and
provide the selected pipeline.

16. The computer system according to claim 15, the stored program instructions further causing the computer system to:
receive libraries for at least one of data imputation, data transformation, and pipeline generation; and
generate a pipeline according to the at least one of the data imputation, data transformation and pipeline generation library.

17. The computer system according to claim 15, the stored program instructions further causing the computer system to provide an explanation of forecast time-series data using information from at least one of the target variable time-series data and the exogenous variable time-series data.

18. The computer system according to claim 17, the stored program instructions further causing the computer system to provide an explanation of forecast time-series data according to past and future exogenous variable data.

19. The computer system according to claim 15, the stored program instructions further causing the computer system to concurrently evaluate the regular and exogenous pipelines under a common framework.

20. The computer system according to claim 15, the stored program instructions further causing the computer system to impute missing data for at least one of the target variable time-series data and the exogenous variable time-series data.
